(19) United States
(12) Patent Application Publication
(10) Pub. No.: US 2005/0195615 A1
(43) Pub. Date: Sep. 8, 2005

(54) Automobile headlight housing

(75) Inventor: Hisanori Takenaka, Kariya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 11/063,881

(22) Filed: Feb. 24, 2005

(30) Foreign Application Priority Data
Mar. 3, 2004 (JP) 2004-58532

(51) Int. Cl. F21V 21/30; F21V 15/04; F21V 11/00; F21V 15/01

(52) U.S. Cl. 362/546; 362/507; 362/538

(57) ABSTRACT

Headlight components including a bulb and a reflector are contained in a headlight housing, and a rear opening of the headlight housing is closed with a back cover. A circuit board is mounted on an inner surface of the back cover, and an impact-alleviating member is connected to or formed on an outer surface of the back cover. An external impact applied to circuit board through the back cover is alleviated by resiliency or plasticity of the impact-alleviating member. Thus, the circuit board is well protected from the external impact. The impact-alleviating member may be plural projections standing up from the outer surface of the back cover, or may be formed in various shapes.

### CROSS-REFERENCE TO RELATED APPLICATION

This application is based upon and claims benefit of priority of Japanese Patent Application No. 2004-58532 filed on Mar. 3, 2004, the content of which is incorporated herein by reference.

### BACKGROUND OF THE INVENTION

1. Field of the Invention

The present invention relates to an automobile headlight housing in which a circuit board for controlling lighting operation is contained.

2. Description of Related Art

It has been proposed to contain a circuit board for controlling lighting operation of a headlight such as a metal-halide lamp in order to save a space and to suppress emission of noises from a high voltage components mounted on the circuit board. An example of a headlight housing in which a circuit board is mounted on an inner surface of a back cover is disclosed in JP-A-2003-51212.

In such a conventional structure of the headlight housing, there has been a possibility that tools for mounting the headlight housing on a vehicle or for performing maintenance hit the back cover and cause damages to the circuit board contained inside the back cover.

### SUMMARY OF THE INVENTION

The present invention has been made in view of the above-mentioned problem, and an object of the present invention is to provide an improved automobile headlight housing, wherein a circuit board contained therein is well protected from an external impact imposed on a back cover of the housing.

Components of the automobile headlight including a bulb and a reflector are contained in a headlight housing. A rear opening of the headlight housing is closed with a back cover. A circuit board for controlling lighting operation including a substrate such as a ceramic substrate is mounted on an inner surface of the back cover. A member for alleviating an external impact imposed on the circuit board through the back cover is connected to or formed on an outer surface of the back cover.

The impact-alleviating member is resiliently or plastically deformed when the external impact is applied thereto to thereby absorb or decrease the external impact imposed on the circuit board. Thus, the circuit board is prevented from being damaged by the external impact. The circuit board is well protected even when it includes a ceramic substrate that is not strong against the external impact.

The impact-alleviating member may be a member having plural projections sticking out from the outer surface of the back cover. The projection may have a cross-section such as a rectangular, stepped rectangular, triangular or tapered cross section. The projection may include a thin portion at its foot, tip or middle portion to provide more resiliency or plasticity to the projection. Alternatively, one or more rubber sheets may be pasted on the outer surface of the back cover as the impact-alleviating member. The impact-alleviating member maybe formed to include an inner hollow space so that the impact-alleviating member easily deforms in response to the external impact. The impact-alleviating member may be made in an L-shape forming a hollow space between the outer surface of the back cover and the impact-alleviating member. One or more pairs of the L-shaped members may be formed on the outer surface of the back cover. Plural knurls functioning as the impact-alleviating member may be formed on the outer surface of the back cover.

Other objects and features of the present invention will become more readily apparent from a better understanding of the preferred embodiment described below with reference to the following drawings.

### BRIEF DESCRIPTION OF THE DRAWINGS

FIG. 1A is a cross-sectional view showing a headlight housing in which a circuit board is contained, as an embodiment of the present invention;

FIG. 1B is a cross-sectional view showing an impact-alleviating member used in the housing shown in FIG. 1A;

FIG. 2A is a cross-sectional view showing a headlight housing in which a circuit board is contained, as a modified form;

FIG. 2B is a cross-sectional view showing an impact-alleviating member used in the housing shown in FIG. 2A;

FIG. 3A is a cross-sectional view showing a headlight housing in which a circuit board is contained, as a modified form;

FIG. 3B is a cross-sectional view showing an impact-alleviating member used in the housing shown in FIG. 3A;

FIG. 4A is a cross-sectional view showing a headlight housing in which a circuit board is contained, as a modified form;

FIG. 4B is a cross-sectional view showing an impact-alleviating member used in the housing shown in FIG. 4A;

FIG. 5A is a cross-sectional view showing a headlight housing in which a circuit board is contained, as a modified form;

FIG. 5B is a cross-sectional view showing an impact-alleviating member used in the housing shown in FIG. 5A;

FIG. 6 is a cross-sectional view showing a headlight housing in which a circuit board is contained, as a modified form;

FIG. 7 is a cross-sectional view showing a headlight housing in which a circuit board is contained, as a modified form;

FIG. 8A is a cross-sectional view showing a headlight housing in which a circuit board is contained, as a modified form;

FIG. 8B is a cross-sectional view showing an impact-alleviating member used in the housing shown in FIG. 8A;

FIG. 9A is a cross-sectional view showing a headlight housing in which a circuit board is contained, as a modified form;

FIG. 9B is a cross-sectional view showing an impact-alleviating member used in the housing shown in FIG. 9A;

FIG. 10A is a cross-sectional view showing a headlight housing in which a circuit board is contained, as a modified form;

FIG. 10B is a cross-sectional view showing an impact-alleviating member formed on an outer surface of a back cover used in the housing shown in FIG. 10A;

### DETAILED DESCRIPTION OF THE PREFERRED EMBODIMENT

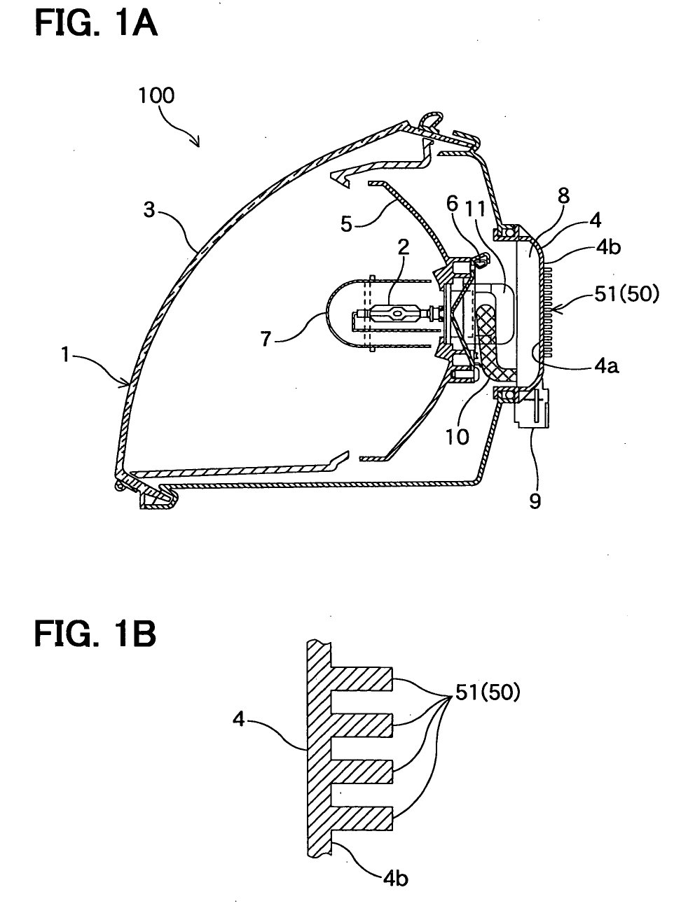

A preferred embodiment of the present invention will be described with reference to accompanying drawings. FIGS. 1A, 2A, 3A, 4A, 5A, 6, 7, 8A, 9A and 10A are all similar except that respectively different impact-alleviating members 50 are used. Therefore, the following description is common to all of these drawings.

A headlight 100 includes a headlight housing 1 containing a bulb 2 such as a metal-halide lamp therein. The front side of the headlight housing 1 is covered with an integrally formed transparent lens 3, and the rear side is closed with a back cover 4. A reflector 5 for reflecting light from the bulb 2 toward the lens 3 is disposed behind the bulb 2. A holder 6 for holding the bulb 2 is positioned behind the reflector 5. A shade 7 for partially interrupting light from the bulb 2 is positioned in front of the bulb 2.

A circuit board 8 for controlling lighting operation is mounted on an inner surface 4a of the back cover 4. The circuit board 8 is electrically connected to an outside power source through a connector 9 and to the bulb 2 through a high voltage wire 10 and a high voltage connector 11. The circuit board 8 is composed of a ceramic substrate and components mounted on the ceramic substrate. Such components include a hybrid IC, a DC-DC converter, an inverter, a starting coil and a control circuit. The ceramic substrate is connected to the inner surface 4a of the back cover 4 with adhesive.

An impact-alleviating member 50 is disposed on the outer surface 4b of the back cover 4. As the impact-alleviating member 50, variously modified members may be used. The impact-alleviating member 50 is resiliently or plastically deformed when an external force is applied thereto thereby to alleviate the external force applied to the circuit board 8. The circuit board 8 is prevented from being damaged by the external force inadvertently applied to the back cover 4 by tools or the like when the headlight 100 is mounted on a vehicle or when maintenance work is performed. The resiliency of the impact-alleviating member 50 absorbs the external impact, and the external impact is decreased by the plastic deformation.

The impact-alleviating member 51 used in the headlight housing 1 shown in FIG. 1A is shown in an enlarged scale in FIG. 1B. The impact-alleviating member 51 includes plural projections standing from the outer surface 4b at a right angle. Each projection has a rectangular cross-section as shown in FIG. 1B. The projections may be integrally formed on a rubber sheet and pasted to the outer surface 4b with adhesive. The projections are resiliently deformable.

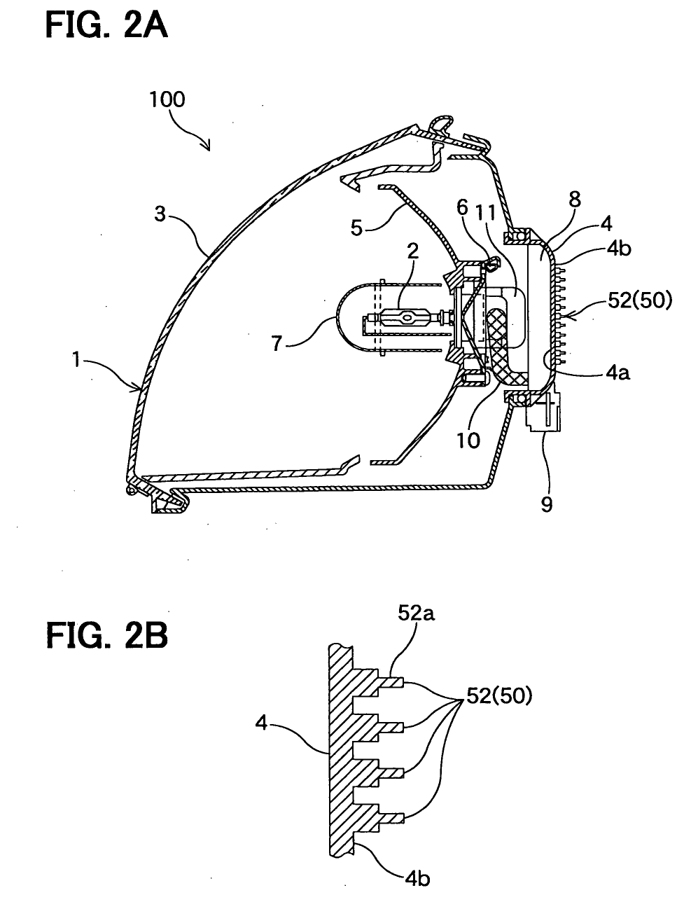

The impact-alleviating member 52 used in the headlight housing 1 shown in FIG. 2A is shown in an enlarged scale in FIG. 2B. The impact-alleviating member 52 includes plural projections standing from the outer surface 4b at a right angle. Each projection has a stepped rectangular cross-section as shown in FIG. 2B. The foot portion of each projection is thick and the tip portion 52a is thin. The projections maybe integrally formed on a rubber sheet and pasted to the outer surface 4b with adhesive. The tip portion 52a resiliently deforms much easier than the foot portion.

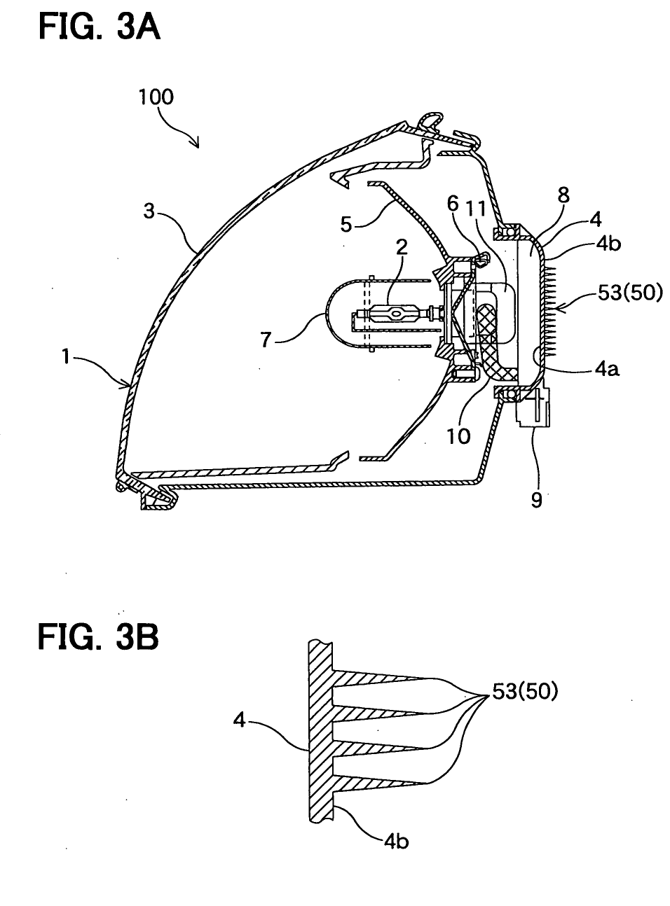

The impact-alleviating member 53 used in the headlight housing 1 shown in FIG. 3A is shown in an enlarged scale in FIG. 3B. The impact-alleviating member 53 includes plural projections standing from the outer surface 4b at a right angle. Each projection has a triangular cross-section as shown in FIG. 3B. The projections may be integrally formed on a rubber sheet and pasted to the outer surface 4b with adhesive. The projections are resiliently deformable.

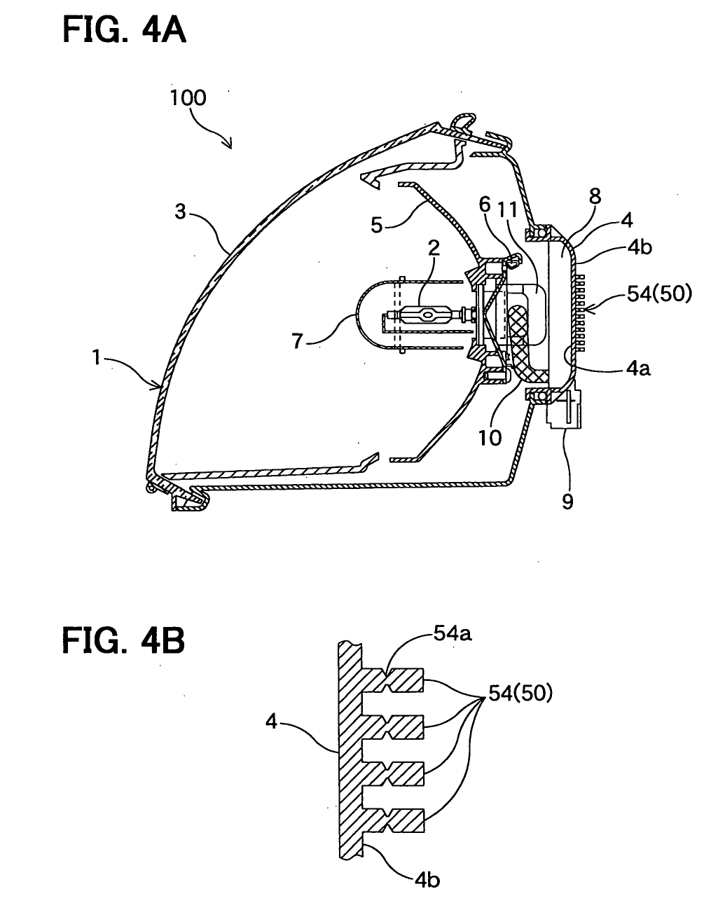

The impact-alleviating member 54 used in the headlight housing 1 shown in FIG. 4A is shown in an enlarged scale in FIG. 4B. The impact-alleviating member 54 includes plural projections standing from the outer surface 4b at a right angle. Each projection has a rectangular cross-section having a thin portion 54a in the middle as shown in FIG. 4B. The projections may be integrally formed on a rubber sheet and pasted to the outer surface 4b with adhesive. The projections are resiliently or plastically bent at the thin portion 54a.

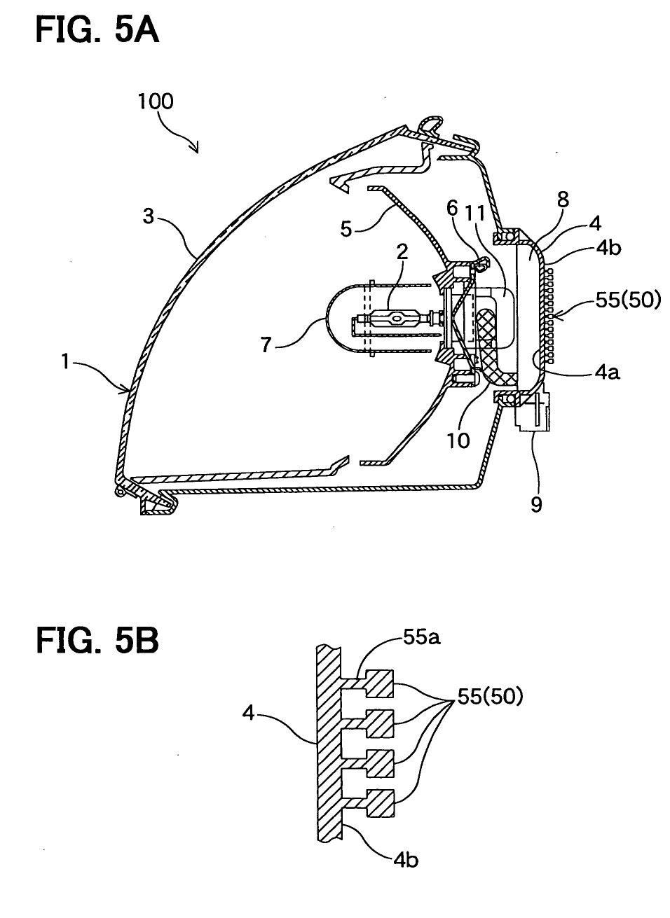

The impact-alleviating member 55 used in the headlight housing 1 shown in FIG. 5A is shown in an enlarged scale in FIG. 5B. The impact-alleviating member 55 includes plural projections standing from the outer surface 4b at a right angle. Each projection has a stepped rectangular cross-section having a thin base portion 55a as shown in FIG. 5B. The projections may be integrally formed on a rubber sheet and pasted to the outer surface 4b with adhesive. The projections are resiliently or plastically deformable and easily bent at the thin base portion 55a.

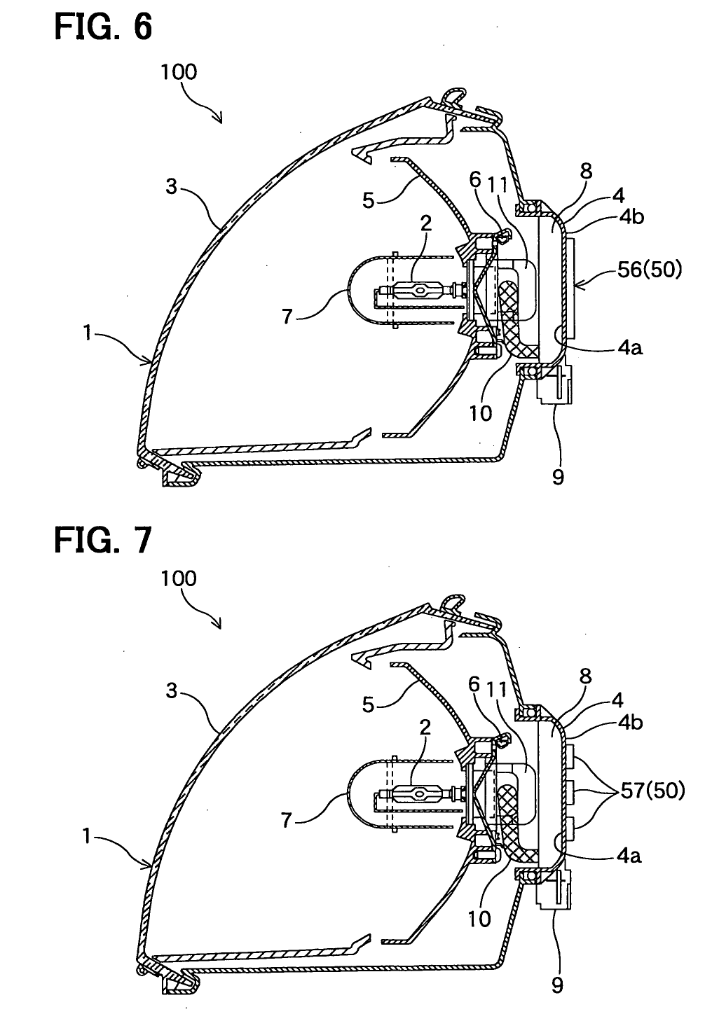

The impact-alleviating member 56 used in the headlight housing 1 shown in FIG. 6 is a single rubber sheet pasted on the outer surface 4b of the back cover 4. The rubber sheet absorbs an external impact by its resilient deformation. The impact-alleviating member 57 used in the headlight housing 1 shown in FIG. 7 is plural rubber sheets each pasted on the outer surface 4b. The plural rubber sheets absorb an internal impact by resilient deformation.

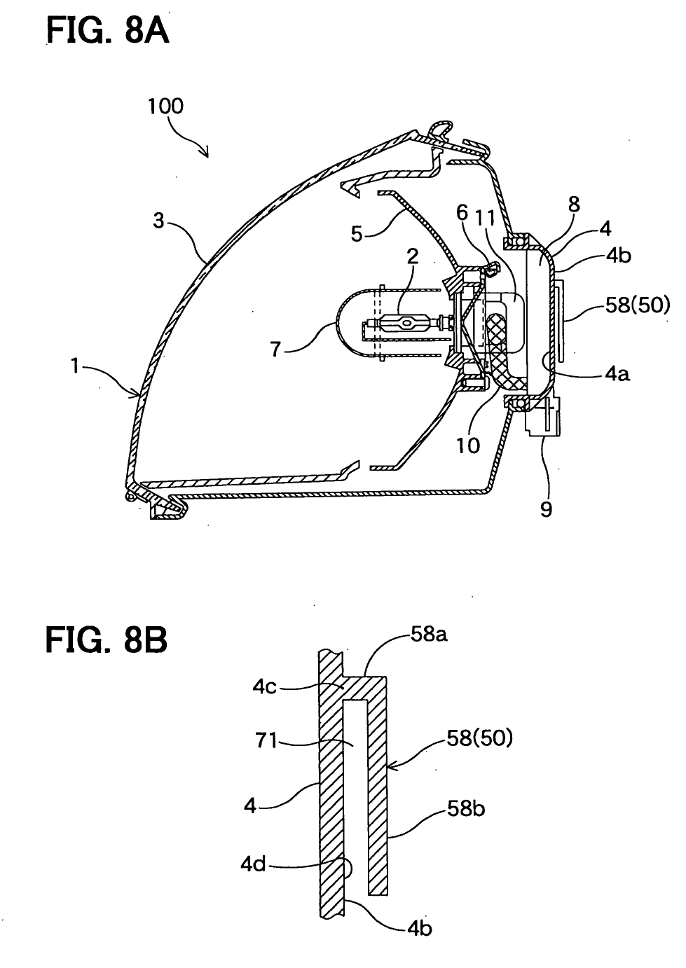

The impact-alleviating member 58 used in the headlight housing 1 shown in FIG. 8A is shown in an enlarged scale in FIG. 8B. The impact-alleviating member 58 is an L-shaped member composed of a base portion 58a standing from one end 4c of the back cover 4 and a parallel portion 58b extending in parallel to the outer surface 4b toward the other end 4d of the back cover 4. A hollow space 71 is formed between the outer surface 4b and the parallel portion 58b. Two or more L-shaped members may be formed on the rear cover 4. The L-shaped member is resiliently or plastically deformable.

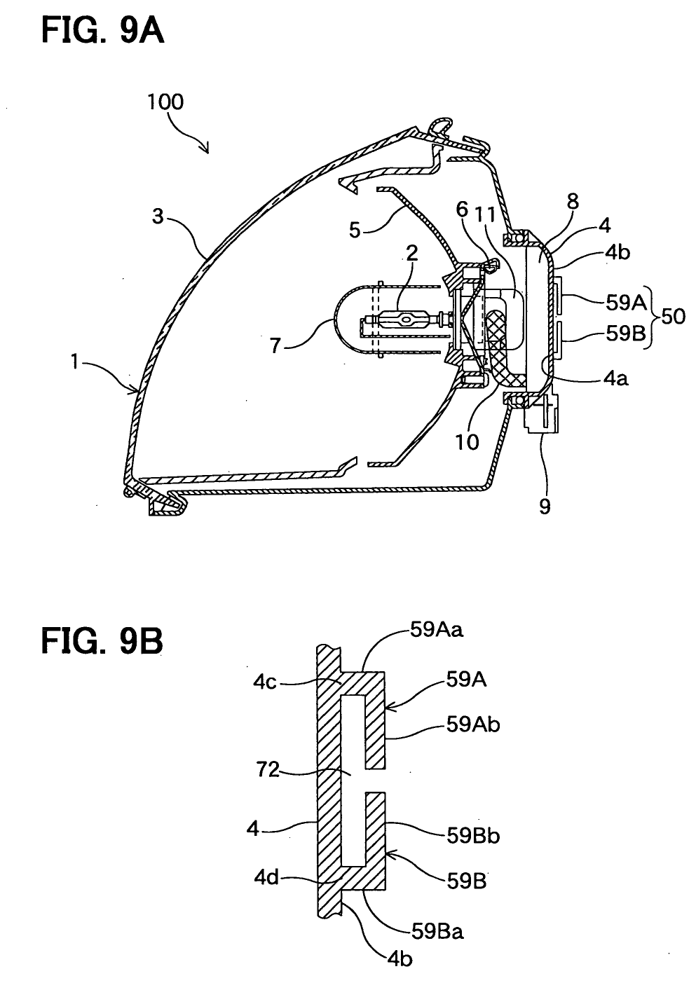

The impact-alleviating members 59A and 59B used in the headlight housing 1 shown in FIG. 9A is shown in an enlarged scale in FIG. 9B. The impact-alleviating member 59A is an L-shaped member composed of a base portion 59Aa standing from one end 4c of the back cover 4 and a parallel portion 59Ab extending in parallel to the outer surface 4b toward the other end 4d of the back cover 4. The impact-alleviating member 59B is an L-shaped member composed of a base portion 59Ba standing from the other end 4d of the back cover 4 and a parallel portion 59Bb extending in parallel to the outer surface 4b toward the one end 4c of the back cover 4. The impact-alleviating members 59A and 59B constitute a pair facing each other as shown in FIG. 9B, and the pair forms a hollow space 72 between the outer surface 4b of the back cover 4 and the parallel portions 59Ab, 59Bb. Tow or more pairs may be formed on the back cover 4. The L-shaped members 59A and 59B are resiliently or plastically deformable.

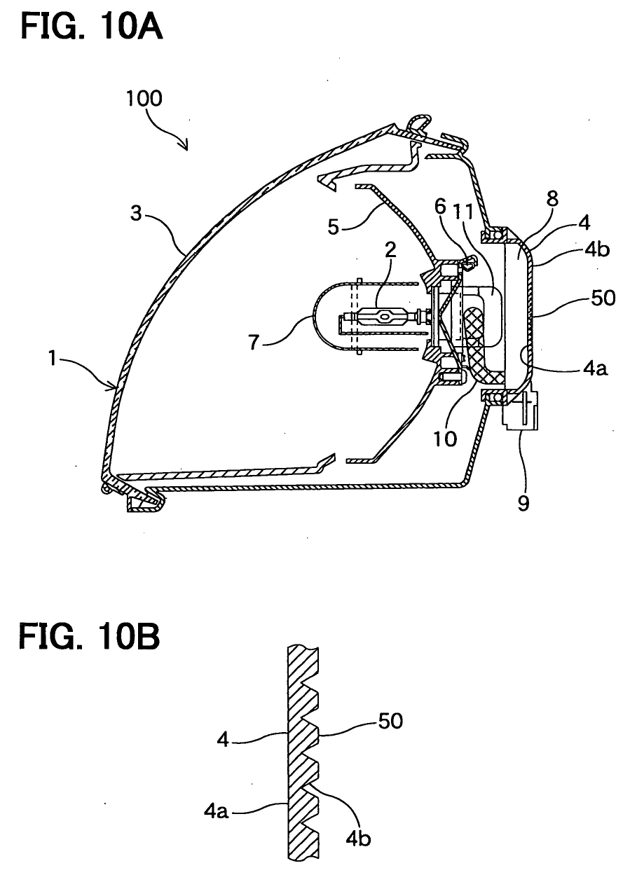

On the outer surface 4b of the back cover 4 used in the headlight housing 1 shown in FIG. 10A, knurls that function as the impact-alleviating member 50 are formed. The knurls are shown in an enlarged scale in FIG. 10B. The knurls are plastically deformable when an external impact is applied thereto.

According to the present invention, the impact-alleviating member 50, which may be variously modified as shown above, is connected to or formed on the outer surface 4b of the back cover 4. The circuit board 8 mounted on the inner surface 4a of the back cover 4 is prevented from being damaged by an external impact force applied to the back cover 4. In other words, the external impact is alleviated by the impact-alleviating member 50. As the substrate of the circuit board 8, various materials such as bakelite, glass-epoxy or ceramics, may be used. When the ceramics such as alumina which is not strong against the external impact are used as the substrate, the impact-alleviating member 50 according to the present invention is especially effective.

While the present invention has been shown and described with reference to the foregoing preferred embodiment, it will be apparent to those skilled in the art that changes in form and detail may be made therein without departing from the scope of the invention as defined in the appended claims.

1. An automobile headlight housing containing a circuit board for controlling lighting operation therein, the automotive headlight housing comprising:
a back cover covering a rear opening of the headlight housing, the circuit board being mounted on an inner surface of the back cover; and
means for alleviating an external impact applied to the circuit board through the back cover, the alleviating means being disposed on an outer surface of the back cover.

2. The automobile headlight housing as in claim 1, wherein the alleviating means is a resiliently deformable member.

3. The automobile headlight housing as in claim 1, wherein the alleviating means is a plastically deformable member.

4. The automobile headlight housing as in claim 1, wherein the alleviating means is a member having a plurality of projections sticking out from the outer surface of the back cover.

5. The automobile headlight housing as in claim 4, wherein each projection has a rectangular cross-section.

6. The automobile headlight housing as in claim 4, wherein each projection has a stepped rectangular cross-section including a larger foot portion and a smaller tip portion.

7. The automobile headlight housing as in claim 4, wherein each projection has a triangular cross-section tapering off toward a tip portion of the projection.

8. The automobile headlight housing as in claim 4, wherein each projection has a cross-section having a smaller cross-sectional area at a tip portion than at a foot portion.

9. The automobile headlight housing as in claim 4, wherein each projection has a cross-section having a thin portion at a middle portion of the projection.

10. The automobile headlight housing as in claim 4, wherein each projection has a cross-section having a thin portion at a foot portion of the projection.

11. The automobile headlight housing as in claim 1, wherein the alleviating means is a rubber sheet pasted on the outer surface of the back cover.

12. The automobile headlight housing as in claim 1, wherein the alleviating means is a plurality of rubber sheets each pasted on the outer surface of the back cover.

13. The automotive headlight housing as in claim 1, wherein the alleviating means is a member having a hollow space therein, the member being resiliently or plastically deformable toward the outer surface of the back cover when an external impact is applied thereto.

14. The automobile headlight housing as in claim 1, wherein the alleviating means is an L-shaped member composed of a base portion standing from the outer surface of the back cover at a right angle and a parallel portion extending in parallel to the outer surface of the back cover, forming a hollow space between the outer surface and the parallel portion.

15. The automobile headlight housing as in claim 14, wherein the alleviating means is composed of one or more pairs of the L-shaped members, the L-shaped members being facing each other in each pair.

16. The automobile headlight housing as in claim 1, wherein the alleviating means is knurls formed on the outer surface of the back cover.

17. The automobile headlight housing as in claim 1, wherein a substrate of the circuit board is a ceramic substrate.
